(19) United States
(12) Patent Application Publication
(10) Pub. No.: US 2025/0076103 A1
(43) Pub. Date: Mar. 6, 2025

(54) LASER DOPPLER VIBROMETER AND VIBRATION MEASUREMENT METHOD

(71) Applicant: Oki Electric Industry Co., Ltd., Tokyo (JP)

(72) Inventor: Shin ARAHIRA, Tokyo (JP)

(73) Assignee: Oki Electric Industry Co., Ltd., Tokyo (JP)

(21) Appl. No.: 18/758,974

(22) Filed: Jun. 28, 2024

(30) Foreign Application Priority Data
Aug. 31, 2023 (JP) 2023-141524

(51) Int. Cl. G01H 9/00

(52) U.S. Cl. CPC G01H 9/00

(57) ABSTRACT

A laser Doppler vibrometer includes a first optical coupler configured to split laser light from a laser light source into two beams of laser light, and one of which is as irradiation light and an other is local light, a sensor head configured to receive the irradiation light come from the first optical coupler through a first optical path, irradiate a measurement target with the irradiation light through a second optical path, receive, through the second optical path, measurement light obtained when the irradiation light is reflected by the measurement target, and cause the measurement light to propagate through the first optical path, a second optical coupler configured to generate interference light by causing the measurement light having propagated through the first optical path and the local light to interfere with each other and an electrical processing system configured to calculate a vibration state of the measurement target from the interference light. The sensor head includes a faraday rotator that rotates a polarization 45°.

### CROSS REFERENCE TO RELATED APPLICATION(S)

This application is based upon and claims benefit of priority from Japanese Patent Application No. 2023-141524, filed on Aug. 31, 2023, the entire contents of which are incorporated herein by reference.

### BACKGROUND

The present invention relates to a laser Doppler vibrometer and a vibration measurement method that can be performed by this laser Doppler vibrometer.

First, an outline of a conventional laser Doppler vibrometer will be described (see, for example, JP 2001-159560 A).

The conventional laser Doppler vibrometer splits laser light generated by a laser light source into two beams of laser light, and generates one beam of the laser light as irradiation light and the other beam of the laser light as local light. When the irradiation light is radiated on a measurement target, the irradiation light is reflected by the measurement target. Measurement light reflected as the irradiation light causes frequency shift due to a Doppler effect according to a vibration state of the measurement target, and this frequency shift appears as a phase change. Consequently, when the phase change caused by the measurement target can be measured, it is possible to learn the vibration state of the measurement target.

Generally, a laser Doppler vibrometer extracts phase information using heterodyne detection that detects interference fringes of the measurement light and the local light with respectively different wavelengths by an optical-to-electrical converter (O/E converter).

Conventionally, contact-type vibration sensors that are widely used for vibration measurement have difficulty in measuring vibration of a distant object or an object at a high temperature or in a high magnetic field. By contrast with the contact-type vibration sensors, the laser Doppler vibrometer can perform contactless measurement by radiating light from a distant place, and consequently can also measure these vibrations.

There is known a laser Doppler vibrometer in which a sensor head section that receives an input of and outputs light to a measurement target, and includes an objective lens and the other simple optical elements, and a measurement section that causes local light and signal light to interfere with each other, receives interference light caused by the interference, or performs signal processing on an electrical signal obtained by receiving the interference light are separated (see, for example, JP 2022-67148 A).

By employing a configuration described in JP 2022-67148 A, it is possible to use a 1.3 μm band or a 1.5 μm band used for optical communication as a laser light wavelength. Consequently, it is possible to use long optical fibers with little loss, and the measurement section and the sensor head can be installed several 100 meters or more apart. The sensor head section basically includes only small optical parts such as an objective lens, and can be miniaturized.

A configuration that uses such long optical fibers for optical paths of measurement light is desirable particularly in environment of use that makes it difficult to install a large sensor head section and measurement section and the like near a measurement target due to restriction of a device installation environment or the like. In addition, the following two documents are disclosed.

Hidetoshi Kumagai, Takashi Yamamoto, Masato Koashi, and Nobuyuki Imoto, “Robustness of quantum communication based on a decoherence-free subspace using a counter-propagating weak coherent light pulse,” Physical Review A 87, 052325-Published 28 May, 2013.

Amnon Yariv, “Operator algebra for propagation problems involving phase conjugation and nonreciprocal elements,” APPLIED OPTICS, Vol. 26, No. 21, pp. 4538-4540, 1 November, 1987.

### SUMMARY

One of problems of a laser Doppler vibrometer that uses long optical fibers is polarization rotation in the optical fibers.

Generally, birefringence caused by manufacturing accuracy or the like remains in optical fibers. A value of this birefringence is quantitatively evaluated as a statistical value called Polarization Mode Dispersion (PMD). PMD of a general optical communication optical fiber takes a value that is approximately 0.1 to 1 ps/(km)^{1/2}, and it is estimated based on this value that 2π of a light phase difference is produced between orthogonal polarizations in a propagation distance of approximately 6 cm to 6 m. This phase difference readily changes due to a change in environmental temperature or the like, and it is very difficult to control the phase difference.

When long optical fibers of several 100 meters are used, a polarization state of measurement light returning from a measurement target is generally unstable, and it is also difficult to control the polarization state. In the worst case, a case is also assumed where polarizations of measurement light and local light input to an optical interferometer are orthogonal to each other, and it is impossible to measure vibration of a measurement target at this time.

JP 2022-67148 A has proposed a laser Doppler vibrometer that includes a receiver employing a polarization diversity configuration. That is, two beams of local light whose polarizations are orthogonal to each other are prepared, and, even when measurement light is input to the optical interferometer in any polarization state, it is possible to obtain an interference fringe with the local light at all times, and measure vibration by heterodyne detection or homodyne detection.

On the other hand, in a case where the above receiver employing the polarization diversity configuration is used, it is necessary to provide an optical interferometer and an optical detector for respective beams of measurement light whose polarizations are orthogonal, and therefore it is necessary to provide two sets of the optical interferometer and optical detector. Therefore, there are problems of increase in size and cost of a device main body.

The present invention has been made in light of the above-described problem. An object of the present invention is to provide a small and low-cost laser Doppler vibrometer and vibration measurement method that can be configured by one set of an optical interferometer and an optical detector even in a case where long optical fibers are used.

In order to achieve the above-mentioned object, the laser Doppler vibrometer of the present invention includes a first optical coupler configured to split laser light from a laser light source into two beams of laser light, and one of which is as irradiation light and an other is local light, a sensor head configured to receive the irradiation light come from by the first optical coupler through a first optical path, irradiate a measurement target with the irradiation light through a second optical path, receive, through the second optical path, measurement light obtained when the irradiation light is reflected by the measurement target, and cause the measurement light to propagate through the first optical path, a second optical coupler configured to generate interference light by causing the measurement light having propagated through the first optical path and the local light to interfere with each other and an electrical processing system configured to calculate a vibration state of the measurement target from the interference light. The sensor head includes a faraday rotator that rotates a polarization 45°.

The laser Doppler vibrometer may further include an optical multiplexer/demultiplexer configured to output from a second input/output port the irradiation light having being input to a first input/output port and generated by the first optical coupler and cause the irradiation light to propagate through the first optical path, and output from a third input/output port the measurement light having being input to the second input/output port and having propagated through the first optical path and a polarization rotator configured to rotate 900 a polarization of the measurement light output from the third input/output port of the optical multiplexer/demultiplexer, and send the measurement light to the second optical coupler.

The laser Doppler vibrometer may further include a first optical multiplexer/demultiplexer configured to output from a second input/output port the irradiation light having being input to a first input/output port and generated by the first optical coupler and cause the irradiation light to propagate through the first optical path, and output from a third input/output port the measurement light having being input to the second input/output port and having propagated through the first optical path and send the measurement light to the second optical coupler, a second optical multiplexer/demultiplexer configured to output from the second input/output port the local light having being input to the first input/output port and generated by the first optical coupler and cause the local light to propagate through a third optical path, and output from the third input/output port the local light having being input to the second input/output port and having propagated through the third optical path and send the local light to the second optical coupler and a faraday rotator mirror provided on an opposite side of the third optical path to the second optical multiplexer/demultiplexer.

A vibration measurement method may include splitting laser light into two beams of laser light, and generating one beam of the laser light as irradiation light and an other beam of the laser light as local light, receiving the irradiation light through a first optical path, rotating a polarization 45°, and then irradiating a measurement target with the irradiation light through a second optical path, receiving, through the second optical path, measurement light obtained when the irradiation light is reflected by the measurement target, then rotating a polarization 45°, and causing the measurement light to propagate through the first optical path, generating interference light by causing the measurement light having propagated through the first optical path and the local light to interfere with each other and acquiring information of vibration of the measurement target from the interference light. The polarization is rotated 45° twice non-reciprocally.

The vibration measurement method may further include rotating 90° the polarization of the measurement light having propagated through the first optical path before generating the interference light.

The vibration measurement method may further include causing the local light to propagate through a third optical path before generating the interference light, rotating 90° a polarization of the local light having propagated through the third optical path and causing the local light whose polarization has been rotated 90° to propagate through the third optical path again.

According to the laser Doppler vibrometer according to the present invention, the sensor head includes a faraday rotator that rotates a polarization 45°, so that it is possible to obtain a polarization of measurement light that propagates bidirectionally in the first optical path and the second optical path as the polarization orthogonal to initially emitted local light irrespectively of polarization rotation in the first optical path. As a result, a simple configuration makes it possible to cause the same polarizations of the local light and the measurement light to interfere with each other at all times without the influence by polarization rotation in the optical fibers even in a case where the long optical fibers are used. Consequently, it is possible to provide a low-cost and highly stable laser Doppler vibrometer and vibration measurement method that can measure vibration at a maximum SN ratio that is expected at the same measurement light intensity.

### BRIEF DESCRIPTION OF DRAWINGS

FIG. 1 is a schematic view for describing a first vibrometer.

FIG. 2A is a view illustrating a result obtained by calculating an x polarization intensity |Eₓ|² of output light after reciprocation in a case where there are functions of birefringence and PDL.

FIG. 2B is a view illustrating a result obtained by calculating the x polarization intensity |Eₓ|² of output light after reciprocation in a case where there are functions of birefringence and PDL.

FIG. 3 is a schematic view for describing the system for demonstrating the effect of the first vibrometer.

FIG. 4A is a view illustrating a result obtained by demonstrating the effect of the first vibrometer.

FIG. 4B is a view illustrating a result obtained by demonstrating the effect of the first vibrometer.

FIG. 5 is a schematic view for describing a second vibrometer.

FIG. 6 is a schematic view for describing a faraday rotator mirror.

FIG. 7 is a schematic view for describing an other configuration example of a sensor head.

### DETAILED DESCRIPTION OF THE EMBODIMENT(S)

With reference to the drawings, the following describes embodiments of the present invention, but each diagram is merely illustrated so schematically that the present invention can be understood. In addition, the following describes a preferable configuration example of the present invention, but it is a mere preferable example. Thus, the present invention is not limited to the following embodiments. A large number of changes or modifications that can attain the advantageous effects of the present invention can be made without departing from the configuration scope of the present invention. It should be noted that, in this specification and the appended drawings, structural elements that have substantially the same function and structure are denoted with the same reference signs, and repeated explanation thereof is omitted.

### (First Vibrometer)

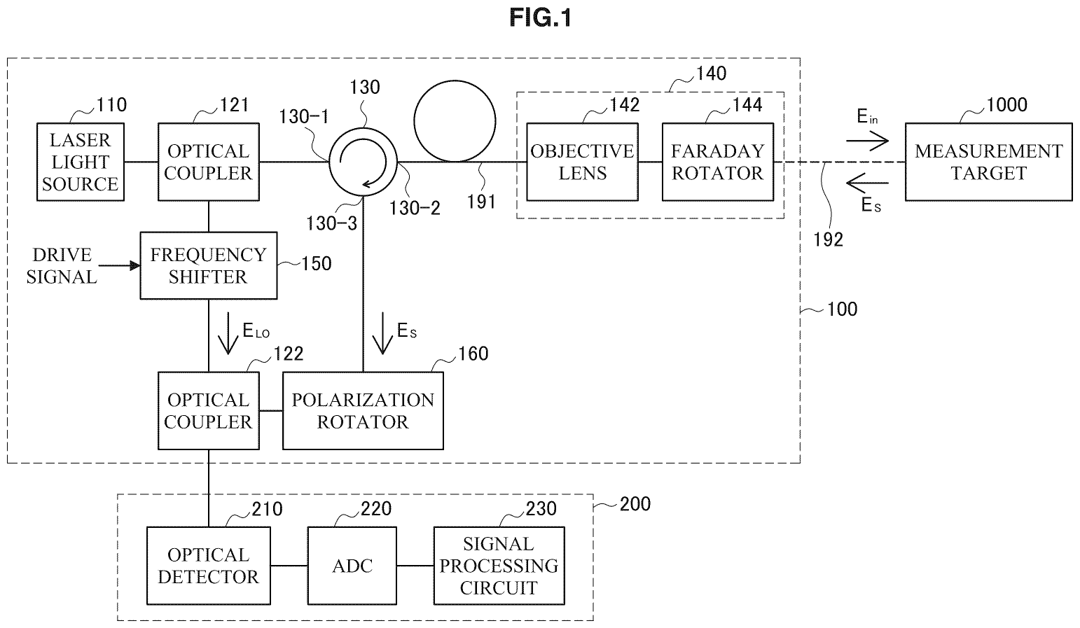

A laser Doppler vibrometer (hereinafter, also referred to as a first vibrometer) according to the first embodiment of the present invention will be described with reference to FIG. 1. FIG. 1 is a schematic view for describing the first vibrometer.

The first vibrometer splits laser light generated by a laser light source into two beams of irradiation light and local light, and detects phase shift deriving from a Doppler effect included in measurement light, from the measurement light generated when the measurement target is irradiated with the irradiation light, and the local light using an optical interferometer to measure vibration of a measurement target.

Hereinafter, an example will be described where heterodyne detection for causing the measurement light and the frequency-shifted local light to interfere with each other. However, a configuration where homodyne detection is performed may be employed.

The first vibrometer includes a laser light source 110, a first optical coupler 121, an optical circulator 130 that is an optical multiplexer/demultiplexer, a sensor head 140, a frequency shifter 150, a polarization rotator 160, and a second optical coupler 122 as an optical processing system 100. Furthermore, the first vibrometer includes an optical detector 210, an Analog-to-Digital Converter (ADC) 220, and a signal processing circuit 230 as an electrical processing system 200.

The laser light source 110 generates laser light that is continuous light oscillated at a center frequency f₀. The laser light generated by the laser light source 110 is sent to the first optical coupler 121.

The first optical coupler 121 splits the laser light sent from the laser light source 110 into two beams of laser light. One of the two split beams of the laser light is sent as irradiation light Eᵢₙ to the optical circulator 130. Furthermore, the other one of the two split beams of the laser light is sent as local light E_{LO} to the frequency shifter 150.

A power split ratio of the first optical coupler 121 is set arbitrarily. The power split ratio is selected such that the local light E_{LO} of appropriate power is input to the second optical coupler 122, and a Signal to Noise (SN) ratio of the measurement light from the measurement target does not substantially diminish.

The optical circulator 130 includes first to third input/output ports 130-1 to 130-3. In the optical circulator 130, light input to the first input/output port 130-1 is output from the second input/output port 130-2, and light input to the second input/output port 130-2 is output from the third input/output port 130-3.

The irradiation light Eᵢₙ sent from the first optical coupler 121 to the optical circulator 130 is input to the first optical coupler 130-1 of the optical circulator 130. The irradiation light Eᵢₙ input to the first input/output port 130-1 is output from the second input/output port 130-2. The irradiation light Eᵢₙ output from the second input/output port 130-2 is sent to the sensor head 140 through a first optical path 191. The first optical path 191 includes, for example, long optical fibers.

The sensor head 140 radiates the irradiation light Eᵢₙ having propagated through the first optical path 191 toward a measurement target 1000. Furthermore, the sensor head 140 receives the measurement light Eₛ reflected by the measurement target 1000 to propagate to the first optical path 191.

The sensor head 140 includes an objective lens 142 and a faraday rotator 144.

The objective lens 142 is provided to efficiently output the irradiation light and input the measurement light. The objective lens 142 is designed according to the size of the measurement target 1000 and a distance between the sensor head 140 and the measurement target 1000.

Note that a second optical path 192 that optically couples the sensor head 140 and the measurement target 1000 is desirably a free space.

The faraday rotator 144 non-reciprocally rotates 45° a polarization of light to be input. When light propagates bidirectionally in this faraday rotator 144, the polarization rotates 45° in each of an outward route and a return route, and rotates 90° in a round trip. Here, an optical path through which the irradiation light Eᵢₙ, traveling toward the measurement target 1000 will be referred to as the outward route, and an optical path through which the measurement light Eₛ reflected by the measurement target 1000 propagates will be referred to as a return route.

The irradiation light Eᵢₙ, sent to the sensor head 140 through the first optical path 191 is radiated on the measurement target 1000 through the objective lens 142 and the faraday rotator 144, and is reflected by the measurement target 1000. The measurement light Eₛ obtained when the irradiation light Eᵢₙ, is reflected by the measurement target 1000 is sent to the first optical path 191 through the faraday rotator 144 and the objective lens 142.

Note that arrangement of the objective lens 142 and the faraday rotator is set arbitrarily. Here, an example has been described where the faraday rotator 144 is disposed closer to the side of the measurement target 1000 than to the objective lens 142. However, the objective lens 142 may be disposed on the measurement target side.

The measurement light Eₛ having propagated through the first optical path 191 is sent to the optical circulator 130. The measurement light Eₛ sent to the optical circulator 130 through the first optical path 191 is input to the second optical coupler 130-2 of the optical circulator 130. The measurement light input to the second input/output port 130-2 is output from the third input/output port 130-3. The measurement light Eₛ output from the third input/output port 130-2 is sent to the polarization rotator 160.

The polarization rotator 160 rotates 90° the polarization of the measurement light Eₛ output from the third input/output port 130-3 of the optical circulator 130. As the polarization rotator 160, a 1/2 wave plate whose optic axis direction is inclined 45° is a suitable example. Furthermore, in a case where the optical circulator 130 and the second optical coupler 122 are configured as polarization maintaining optical fibers, connecting the optical circulator 130 and the second optical coupler 122 by rotating an optic axis 90° at a connection portion of the optical circulator 130 and the second optical coupler 122 is a suitable example. The measurement light Eₛ obtained by rotating the polarization 90° by the polarization rotator 160 is sent to the second optical coupler 122.

The local light E_{LO} sent from the first optical coupler 121 to the frequency shifter 150 is subjected to frequency shift by the frequency shifter 150. The frequency shifter 150 is, for example, a commercially available Acousto-Optic Modulator (AOM). The frequency shifter 150 shifts an optical frequency of light to be input by a frequency (f_{shift}) of a drive signal of high frequency to be input. The local light E_{LO} subjected to frequency shift by the frequency shifter 150 is sent to the second optical coupler 122.

The second optical coupler 122 causes the measurement light Eₛ sent from the polarization rotator 160 and the local light E_{LO} sent from the frequency shifter 150 to interfere with each other. Interference light obtained when the measurement light and the local light interfere with each other in the second optical coupler 122 is sent to the optical detector 210.

The optical detector 210 photoelectrically converts the interference light sent from the second optical coupler 122. The optical detector 210 has a function to convert a received optical signal into an electrical signal. As the optical detector 210, an arbitrary, suitable, and conventionally known PhotoDiode (PD) can be used. An analog electrical signal photoelectrically converted and obtained by the optical detector includes a beat signal of the frequency f_{shift}. Phase change of this beat signal is phase change caused by vibration of the measurement target 1000. The analog electrical signal generated by the optical detector 210 is sent to the ADC 220.

The ADC 220 digitizes the analog electrical signal, and generates a digital electrical signal. The digital electrical signal generated by the ADC 220 is sent to the signal processing circuit 230.

The signal processing circuit 230 can be configured by, for example, an arbitrary, suitable, and conventionally known electronic computer such as a personal computer. The signal processing circuit 230 executes an arithmetic operation such as filtering for the digital electrical signal, and obtains a measurement result of vibration of a measurement target. Note that, since, as a technology of obtaining a measurement result of vibration of a measurement target based on a digital electrical signal obtained from interference light obtained by heterodyne detection of measurement light and local light, the conventionally known technology disclosed in, for example, JP 2022-67148 A can be used, and description thereof will be omitted.

### (Operation)

An optical system that couples each of the laser light source 110, the first optical coupler 121, the optical circulator 130, the frequency shifter 150, the polarization rotator 160, and the second optical coupler 122 that constitute the optical processing system 100 is configured using a spatial optical system or a polarization maintaining optical fiber, so that the optical processing system can relatively easily maintain a polarization state.

On the other hand, light propagating through the optical fibers that are the first optical path 191 causes polarization rotation.

Here, the operation of the first vibrometer will be described by comparing the conventional technology that does not include a faraday rotator in a sensor head, and the first vibrometer that includes the faraday rotator in the sensor head.

As described above, a conventional laser Doppler vibrometer causes polarization rotation in measurement light at a portion corresponding to the first optical path 191 according to the present invention. On the other hand, as described above, as for local light, the optical system that couples each of components corresponding to the laser light source 110, the first optical coupler 121, the frequency shifter 150, and the second optical coupler 122 is configured using a spatial optical system or a polarization maintaining optical fiber, so that it is easy to maintain the same polarization state of local light input to the second optical coupler 122 as that of laser light output from the laser light source 110.

A polarization state of light input to one end part (first end part) of the optical fiber transmission path corresponding to the first optical path 191 is expressed by the Jones vector Eᵢ=(Eₓᵢ, E_{yi})^{T}, and a polarization state of light that propagates through the optical fiber transmission path and is output from an other end part (second end part) of the optical fiber transmission path is expressed by the Jones vector Eₒ=(Eₓₒ, E_{yo})^{T}.

An input polarization Eᵢ and an output polarization Eₒ satisfy following equation (1) when a transfer function M_{F} of an outward route of the optical fiber transmission path from the first end part to the second end part is used.

$$[ Mathematical 1 ]$$

$${E}_{o} = {M}_{F} {E}_{i} \qquad ( 1 )$$

The transfer function M_{F} is expressed by a 2×2 matrix, and, in a case where there is no loss in the optical fiber transmission path, a determinant of the transfer function M_{F} is one.

On the other hand, a transfer function M_{B} of a return route of the same optical fiber transmission path that is opposite to the outward route and goes from the second end part to the first end part is expressed by following equations (2) and (3) (see, for example, Hidetoshi Kumagai, Takashi Yamamoto, Masato Koashi, and Nobuyuki Imoto).

$$[ Mathematical 2 ]$$

$${M}_{B} = Z {( {M}_{F} )}^{T} Z \qquad ( 2 )$$

$$[ Mathematical 3 ]$$

$$Z = ( \begin{matrix}1 & 0 \\ 0 & - 1\end{matrix} ) \qquad ( 3 )$$

Here, a case will be studied where light input to the first end part of the optical fiber transmission path is specularly reflected by the second end part, propagates in an opposite direction in the same optical fiber transmission path toward the first end part, and is output from the first end part. When the polarization state of the light output from the first end part is expressed by the Jones vector Eᵣₜ=(Eₓᵣₜ, E_{yrt})^{T}, Eᵣₜ is given by following equations (4) and (5).

$$[ Mathematical 4 ]$$

$${E}_{r t} = {M}_{B} Γ {M}_{F} {E}_{1} \qquad ( 4 )$$

$$[ Mathematical 5 ]$$

$$r = ( \begin{matrix}- 1 & 0 \\ 0 & 1\end{matrix} ) \qquad ( 5 )$$

Here, a matrix r is a transformation matrix for performing coordinate transformation between a traveling wave of the outward route and a backward wave of the return route. That is, the matrix r transforms x into −x, and keeps y as y.

Giving a component of the transfer function M_{F} of the outward route by following equation (6), following equation (7) can be obtained from above equation (4).

$$[ Mathematical 6 ]$$

$${M}_{F} = ( \begin{matrix}a & b \\ c & d\end{matrix} ) \qquad ( 6 )$$

$$[ Mathematical 7 ]$$

$${E}_{rt} = ( \begin{matrix}- {a}^{2} - {c}^{2} & - ab - cd \\ ab + cd & {b}^{2} + {d}^{2}\end{matrix} ) {E}_{i} \qquad ( 7 )$$

Here, an x polarization whose polarization state of input light is expressed by Eᵢ=(1, 0)^{T} is assumed. In this case, the polarization state of output light after the output light propagates bidirectionally in the optical fiber transmission path is Eᵣₜ=(−a²−c², ab+cd)^{T}. a, b, c, and d that give the transfer function of the optical fiber transmission path is unstable, and temporally fluctuates. Hence, the polarization state of the output light after the output light propagates bidirectionally in the optical fiber transmission path is unstable, and its control is difficult.

Here, the first vibrometer includes the faraday rotator 144 that is disposed at the second end part side of the first optical path 191 that is the optical fiber transmission path, and the faraday rotator non-reciprocally rotates the polarization 45°. Note that a case will be studied where polarization rotation does not occur in the second optical path 192 between the sensor head 140 and the measurement target 1000 at a time of reciprocation in the second optical path 192. This assumption is effective in a case where the second optical path 192 is free space, and specular reflection is dominant in the reflection from the measurement target 100 reflection from the measurement target 1000.

When the polarization state of the light output from the second end part in a case where the faraday rotator 144 is provided to the sensor head 140 is expressed by the Jones vector Eᵣₜ=(Eₓᵣₜ, E_{yrt})^{T}, Eᵣₜ is given by following equation (8).

$$[ Mathematical 8 ]$$

$${E}_{r t} = {M}_{B} {F}_{B} Γ {F}_{F} {M}_{F} {E}_{1} \qquad ( 8 )$$

Here, F_{F} represents the transfer function of the faraday rotator 144 of the outward route, and F_{B} represents the transfer function of the faraday rotator 144 of the return route. When a polarization rotation angle in the faraday rotator 144 is 45°, F_{F} and F_{B} are given by following equations (9-a) and (9-b) (see, for example, Amnon Yariv).

$$[ Mathematical 9 ]$$

$${F}_{F} = \frac{1}{\sqrt{2}} ( \begin{matrix}1 & 1 \\ - 1 & 1\end{matrix} ) \qquad ( 9 - a )$$

$${F}_{B} = \frac{1}{\sqrt{2}} ( \begin{matrix}1 & - 1 \\ 1 & 1\end{matrix} ) \qquad ( 9 - b )$$

As a result, the polarization state of the light output from the second end part is given by following equation (10).

$$[ Mathematical 10 ]$$

$${E}_{rt} = - ( ad - bc ) ( \begin{matrix}0 & 1 \\ 1 & 0\end{matrix} ) {E}_{i} \qquad ( 10 )$$

Here the x polarization whose polarization state of input light is expressed by Eᵢ=(1, 0)^{T} is assumed. The polarization state of the output light after the output light propagates bidirectionally in the optical fiber transmission path and the faraday rotator is Eᵣₜ=(0, −(ad−bc))^{T}. This indicates that a y polarization is output at all times irrespectively of the transfer function of the optical fiber transmission path.

Note that the relationship of above equation (10) holds even when there is Polarization Dependent Loss (PDL) in the optical fiber transmission path.

By configuring as the polarization maintaining optical system the optical system that includes the laser light source 110, the first optical coupler 121, the frequency shifter 150, the second optical coupler 122, and the optical circulator 130, it is possible to make the irradiation light output from the first input/output port 130-1 of the optical circulator 130 and the local light input to the second optical coupler 122 the same polarization, here, the x polarization.

On the other hand, as described above, when the x polarization is output from the second input/output port 130-2 of the optical circulator 130, and is input to the optical fiber transmission path constituting the first optical path 191, the measurement light that is reflected by the measurement target 1000 through the optical fiber transmission path constituting the first optical path 191, and the faraday rotator 144, propagates through the faraday rotator 144 and the optical fiber transmission path, returns to the optical circulator 130 again, and is input to the second input/output port 130-2 of the optical circulator is the y polarization.

The measurement light that is the y polarization input to the second input/output port 130-2 of the optical circulator 130 is output from the third input/output port 130-3, and sent to the polarization rotator 160 while keeping the y polarization state. The polarization rotator 160 converts the measurement light of the y polarization into the x polarization to send to the second optical coupler 122.

Hence, both of the local light and the measurement light sent to the second optical coupler 122 become the x polarization.

As a result, in the first vibrometer, the second optical coupler 122 receives input of the local light and the measurement light of the same polarization (here, x polarization) independently of the transfer function of the first optical path 191. That is, in the second optical coupler 122, the local light and the measurement light of the same polarization interfere with each other. Hence, beat signals of a maximum modulation depth occurs at all times from the second optical coupler 122 independently of the transfer function of the first optical path 191.

Furthermore, the interference light output from the second optical coupler 122 has the maximum modulation depth among the obtained depths since the polarizations of the local light and the measurement light are the same. Consequently, it is possible to measure vibration at a maximum SN ratio that is expected at the same measurement light intensity.

In the above-described description, the optical circulator is used as the optical multiplexer/demultiplexer. Here, as described above, the polarization of the irradiation light input to the first input/output port 130-1 of the optical circulator 130 and output from the second input/output port 130-2 is fixed to the x polarization, and the polarization of the measurement light input to the second input/output port 130-2 of the optical circulator 130 and output from the third input/output port 130-3 is fixed to the y polarization, so that it is also possible to use a Polarizing Beam Splitters (PBS) as the optical multiplexer/demultiplexer. The PBS is provided such that, when, for example, light of the x polarization and the y polarization is input to the second input/output port, the light of the x polarization is output from the first input/output port, and the light of the y polarization is output from the third input/output port.

The irradiation light Eᵢₙ, of the x polarization sent from the first optical coupler 121 to the PBS is input to the first input/output port of the PBS and is output from the second input/output port. Furthermore, the irradiation light Eᵢₙ, output from the second input/output port 130-2 of the PBS is sent to the sensor head 140 through the first optical path 191. Furthermore, the measurement light Eₛ of the y polarization sent to the PBS through the first optical path 191 is input to the second input/output port of the PBS, and is output from the third input/output port. The measurement light Eₛ output from the third input/output port 130-2 is sent to the polarization rotator 160.

Here, although the case has been described where polarization rotation does not occur in the second optical path 192, a case will be described where polarization rotation occurs at a time of reciprocation at the portion including reflection from a measurement target in the second optical path 192 to make a more general argument. This assumption corresponds to a case where birefringence and PDL occur at the second optical path 192 or the measurement target 1000.

In a case where a transfer function of the outward route of the second optical path 192 is L_{F}, a transfer function LB of the return route is expressed by following equation (11) similarly to equation (2).

$$[ Mathematical 11 ]$$

$${L}_{B} = {Z ( {L}_{F} )}^{T} Z \qquad ( 11 )$$

In this case, a total transfer function Tₜₒₜₐₗ at a time of reciprocation in the first optical path 191 and the second optical path 192 is given by following equation (12).

$$[ Mathematical 12 ]$$

$${T}_{Total} = {M}_{B} {F}_{B} {L}_{B} Γ {L}_{F} {F}_{F} {M}_{F} \qquad ( 12 )$$

Generally speaking, in a case where birefringence or PDL occurring in the second optical path 192 is significant, it is not possible to obtain an effect obtained from the above-described first vibrometer that input light having the x polarization returns as the y polarization after reciprocation.

On the other hand, in a case where birefringence or PDL occurring in the second optical path 192 is moderately little, it is possible to practically sufficiently achieve effectiveness by the use of the first vibrometer.

A transfer function T of an optical part having birefringence or PDL can be expressed by following equation (13) (see, for example, Hidetoshi Kumagai, Takashi Yamamoto, Masato Koashi, and Nobuyuki Imoto).

$$[ Mathematical 13 ]$$

$$T = [ \begin{matrix}{γ}_{x} {e}^{- i ϕ} {cos}^{2} θ + {γ}_{y} {e}^{- i ϕ} {sin}^{2} θ & [ {γ}_{x} {e}^{- i ϕ} - {γ}_{y} {e}^{i ϕ} ] sin θ cos θ \\ [ {γ}_{x} {e}^{- i ϕ} - {γ}_{y} {e}^{- i ϕ} ] sin θ cos θ & {γ}_{x} {e}^{- i ϕ} {sin}^{2} θ + {γ}_{y} {e}^{- i ϕ} {cos}^{2} θ\end{matrix} ] \qquad ( 13 )$$

Here, γₓ and γ_{y} represent amplitude loss of the x polarization and the y polarization, and correspond to PDL. θ represents a rotation direction of the optic axis. Furthermore, the amount of optical phase difference of the x polarization and the y polarization are respectively −φ and +φ. 2φ represents a phase difference of birefringence.

Generally speaking, the transfer function of the second optical path 192 is obtained by multiplying transfer functions of optical parts having a combination of various (γₓ, γ_{y}, θ, and φ).

However, in the first vibrometer, the second optical path 192 includes only an objective lens 142 that is the optical lens and the measurement target 1000, and a free space at most. It may be assumed that the spatial coupling system and the optical lens do not have birefringence and PDL. Consequently, it can be considered that the birefringence and the PDL of the second optical path 192 are substantially caused by the measurement target 1000.

In view of the above observation, in a following argument, a transfer function of a single optical part given by above equation (13) is the transfer function L_{F} of the return route of the second optical path 192.

In this case, a polarization state after reciprocation in the first optical path 191 and the second optical path 192 is given by following equation (14).

$$[ Mathematical 14 ]$$

$${E}_{r t} = {T}_{total} {E}_{1} = {M}_{B} {F}_{B} {L}_{B} Γ {L}_{F} {F}_{F} {M}_{F} {E}_{i} \qquad ( 14 )$$

A desired effect of the first vibrometer is that, when a polarization state of input light is the x polarization (1, 0)^{T}, a polarization state after reciprocation can be approximated to the y polarization (0, 1)^{T}, and output. In this case, even when an x polarization component remains more or less, as long as the x polarization component does not significantly undermine the light intensity of a y polarization component, it is possible to obtain the effect of the invention.

In a case where a matrix element of the total transfer function Tₜₒₜₐₗ is Tᵢⱼ(i, j=1, 2), a polarization state after reciprocation is given as (T₁₁, T₂₁)^{T}. Consequently, it is possible to obtain the desired effect of the first vibrometer when |T₁₁|/|T₂₁| is sufficiently small.

In view of above equations (12) and (13), T₁₁ and T₂₁ are given by following equations (15-a) and (15-b).

$$[ Mathematical 15 ]$$

$${T}_{11} = \frac{1}{2} [ ( {a}^{2} - {c}^{2} ) cos ( 2 θ ) + 2 ac sin ( 2 θ ) ] [ {γ}_{x}^{2} {e}^{- 2 i ϕ} - {γ}_{y}^{2} {e}^{2 i ϕ} ] \qquad ( 15 - a )$$

$${T}_{21} = \frac{1}{2} [ ( ab - cd ) cos ( 2 θ ) + ( ad + bc ) sin ( 2 θ ) ] [ {γ}_{x}^{2} {e}^{- 2 i ϕ} - {γ}_{y}^{2} {e}^{2 i ϕ} ] - \frac{1}{2} ( ad - bc ) [ {γ}_{x}^{2} {e}^{- 2 i ϕ} + {γ}_{y}^{2} {e}^{2 i ϕ} ] \qquad ( 15 - b )$$

Here, when Δθ, Δφ, and γ_{y}=(1+Δγ)γₓ(Δθ, Δγ, Δr <<1) is put assuming that rotation of the optic axis in the second optical path, phase change due to birefringence, and PDL are each sufficiently small, above equations (15-a) and (15-b) can be expressed as following equations (16-a) and (16-b).

$$[ Mathematical 16 ]$$

$${T}_{11} = \frac{1}{2} {γ}_{x}^{2} [ ( {a}^{2} - {c}^{2} ) + 4 ac Δθ ] [ - {( 1 + Δ r )}^{2} ( 1 + 2 i Δϕ ) + 1 - 2 i Δϕ ] \qquad ( 16 - a )$$

$${T}_{21} = \frac{1}{2} {γ}_{x}^{2} [ ( ab - cd ) + 2 ( ad + bc ) Δθ ] [ - {( 1 + Δ r )}^{2} ( 1 + 2 i Δϕ ) + 1 - 2 i Δϕ ] - \frac{1}{2} {γ}_{x}^{2} ( ad - bc ) [ {( 1 + Δ r )}^{2} ( 1 + 2 i Δϕ ) + 1 - 2 i Δϕ ] \qquad ( 16 - b )$$

In above equations (16-a) and (16-b), since loss γₓ² of both of T₁₁ and T₂₁ applies to the entire equations, the loss γₓ² can be ignored in a case where a ratio of |T₁₁|/|T₂₁| is argued.

In a case where Δy and Δr are sufficiently small, a second term on the right side is dominant and a value of T₂₁ given by above equation (16-b) is asymptotic to −(ad−bc). This value matches with a value given by above equation (10) in a case where the second optical path 192 does not have birefringence or PDL.

Hence, to argue the ratio of |T₁₁|/|T₂₁|, attention may be paid to |T₁₁|, and an absolute value of a value of following equation (17) may be argued.

$$[ Mathematical 17 ]$$

$$\frac{1}{2} [ ( {a}^{2} - {c}^{2} ) + 4 ac Δθ ] [ - {( 1 + Δ r )}^{2} ( 1 + 2 i Δϕ ) + 1 - 2 i Δϕ ] \qquad ( 17 )$$

Absolute values of values of a, b, c, and d are approximately one at most in view of characteristics of the transfer function of the optical fiber transmission path. That is, an absolute value of a value in first [ ] on the right side of above equation (17) is approximately one at most. Hence, to what extent a value in second [ ] on the right side becomes large due to birefringence or PDL may be argued for the value of above equation (17).

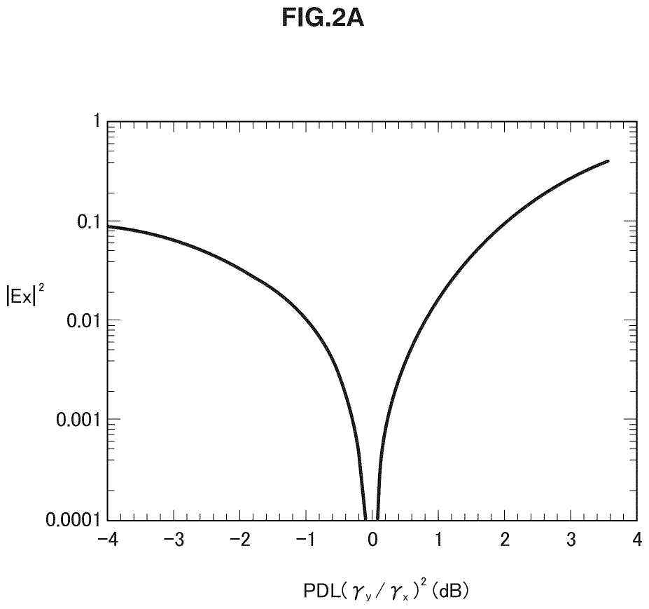

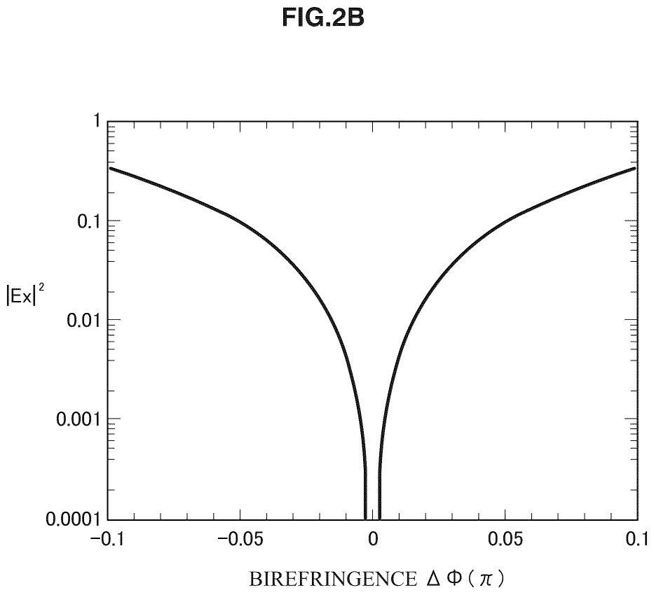

FIGS. 2A and 2B illustrate results obtained by calculating an intensity |Eₓ|² of the x polarization of the output light after reciprocation on the basis of above equation (15-a) in a case where there are functions of birefringence and PDL. Note that γₓ=1 holds, and the value in first [ ] on the right side of above equation (15-a) is also one.

FIG. 2A illustrates a calculation result of PDL dependency when birefringence is zero (φ=0), and FIG. 2B illustrates a calculation result of birefringence dependency when PDL is zero (Δr=0).

In a case where, for example, an acceptable degree of the intensity |Eₓ|² of the x polarization is 0.01 (1% of the total intensity) or less or 0.1 (10% likewise), acceptable PDL is estimated as 0.8 dB (approximately 20%) or less and 2.1 dB (approximately 62%) or less. Furthermore, birefringence is estimated as 0.015 π or less and 0.05 π or less as a phase difference between the x polarization and the y polarization.

As is well known, the amplitude of a detection signal obtained by homodyne detection or heterodyne detection is proportional to a square root of a measurement light intensity. If an x polarization intensity fluctuates at 0 to 0.1 due to an influence of polarization rotation, a y polarization intensity fluctuates at 0.9 to 1. On the other hand, the amplitude of the detection signal fluctuates at 0.95 to 1, and does not fluctuate like fluctuation of the measurement light intensity.

That is, it is supposed that, when fluctuation of the x polarization intensity is approximately 0.1 and hence fluctuation of the y polarization intensity that is a measurement target is approximately 0.1, an influence on measurement performance of vibration measurement is very small. Consequently, it is possible to obtain the effect according to the first embodiment of the present invention even from a measurement target with birefringence or PDL that does not influence the measurement performance of the above-described vibration measurement. An acceptable fluctuation range of the y polarization intensity is set arbitrarily, and depends on, for example, sensitivity, noise, or the like of the optical detector 210.

An experiment for demonstrating the effect of the first vibrometer was conducted.

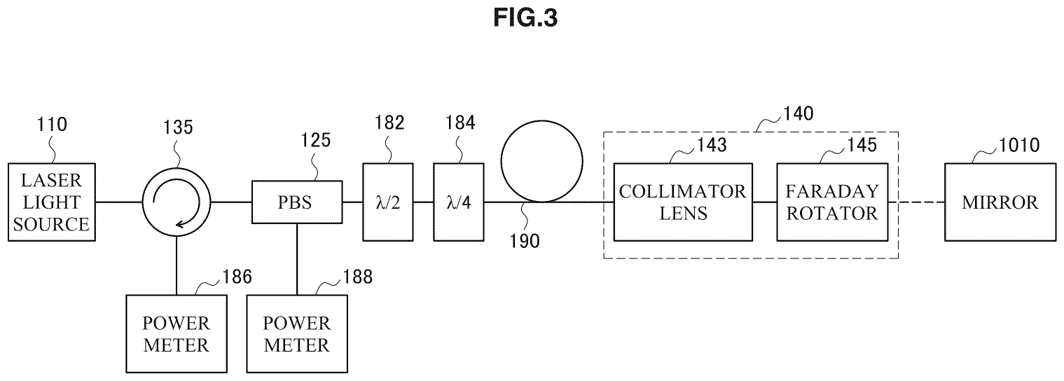

FIG. 3 is a schematic view illustrating a system for demonstrating the effect of the first vibrometer. Laser light of the x polarization whose wavelength was 1550 nm was caused to pass a polarization maintaining optical circulator 135, a Polarization Beam Splitter (PBS) 125, a λ/2 wave plate 182, a λ/4 wave plate 184, a single mode optical fiber 190, a collimator lens (that was made by Thorlabs and whose model number was C20APC-C) 143, and a faraday rotator (that was made by Thorlabs and whose model number was I1550R5) 145, and then was radiated on a mirror 1010. An optical path including the λ/2 wave plate 182, the λ/4 wave plate 184, and the single mode optical fiber 190 corresponds to the first optical path 191 in the first vibrometer. Furthermore, a portion including the collimator lens 143 and the faraday rotator 145 corresponds to the sensor head 140 in the first vibrometer.

Part of reflection light of the mirror 1010 was taken in the faraday rotator 145 and the collimator lens 143, was caused to propagate backward through the first optical path 191 including the single mode optical fiber 190 and the like, and the x polarization intensity and the y polarization intensity after backward propagation were measured by power meters 186 and 188. The optic axes of the λ/2 wave plate 182 and the λ/4 wave plate 184 were rotated, and polarization rotation occurring in the first optical path 191 was simulated to measure changes in the x polarization intensity and the y polarization intensity at this time. Total propagation loss (including the reflectance of the mirror 1010) to an optical system used for the experiment was approximately −3 dB.

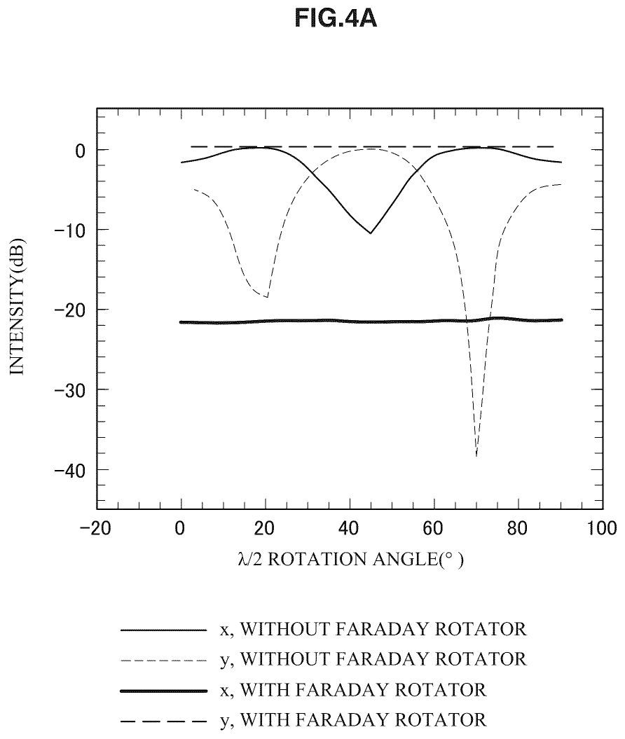

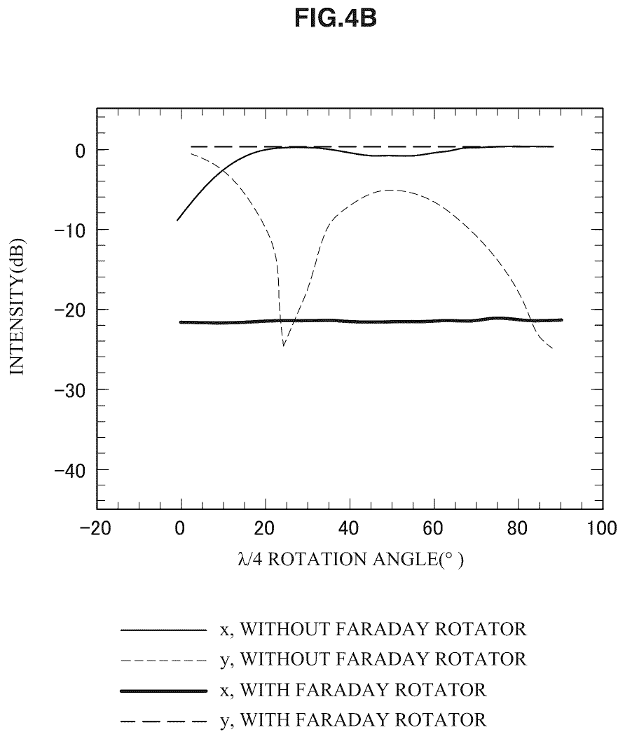

FIGS. 4A and 4B illustrate experiment results. FIG. 4A illustrates a result obtained by rotating the optic axis of the λ/2 wave plate, and FIG. 4B illustrates a result obtained by rotating the optic axis of the λ/4 wave plate. Furthermore, solid lines in FIGS. 4A and 4B indicate the x polarization intensity, and dotted lines indicate the y polarization intensity. Furthermore, bold lines in FIGS. 4A and 4B indicate a result in a case where a faraday rotator is inserted, and thin lines indicate a result of a conventional configuration where a faraday rotator is not inserted. FIG. 4A illustrates that the horizontal axis indicates a rotation angle (°) of the λ/2 wave plate, and FIG. 4B illustrates that the horizontal axis indicates a rotation angle (°) of the λ/4 wave plate. Furthermore, FIGS. 4A and 4B illustrate that the vertical axis indicates the intensity (dB) standardized for total propagation loss.

According to the conventional configuration where the faraday rotator is not inserted, the x polarization intensity and the y polarization intensity significantly fluctuate as the optical axes of the λ/2 wave plate 182 and the λ/4 wave plate 184 rotate. In this regard, a sum of the x polarization intensity and the y polarization intensity was substantially fixed. This means that a polarization state of measurement light significantly fluctuates due to an influence of polarization rotation occurring in the first optical path 191 in the conventional configuration.

On the other hand, in the first vibrometer in which the faraday rotator was inserted, fluctuation of the y polarization intensity was 0.1 dB or less, and the y polarization intensity did not substantially change even when the optical axes of the λ/2 wave plate 182 and the λ/4 wave plate 184 rotated. In view of the above, the effect of the first vibrometer could be demonstrated.

A following effect can be expected from the first vibrometer. That is, a simple configuration makes it possible to cause the local light and the measurement light of the same polarization to interfere with each other at all times without being influenced by polarization rotation in the optical fibers even in a case where the long optical fibers are used. As a result, it is possible to provide a low-cost and highly stable laser Doppler vibrometer that can measure vibration at a maximum SN ratio that is expected at the same measurement light intensity.

### (Second Vibrometer)

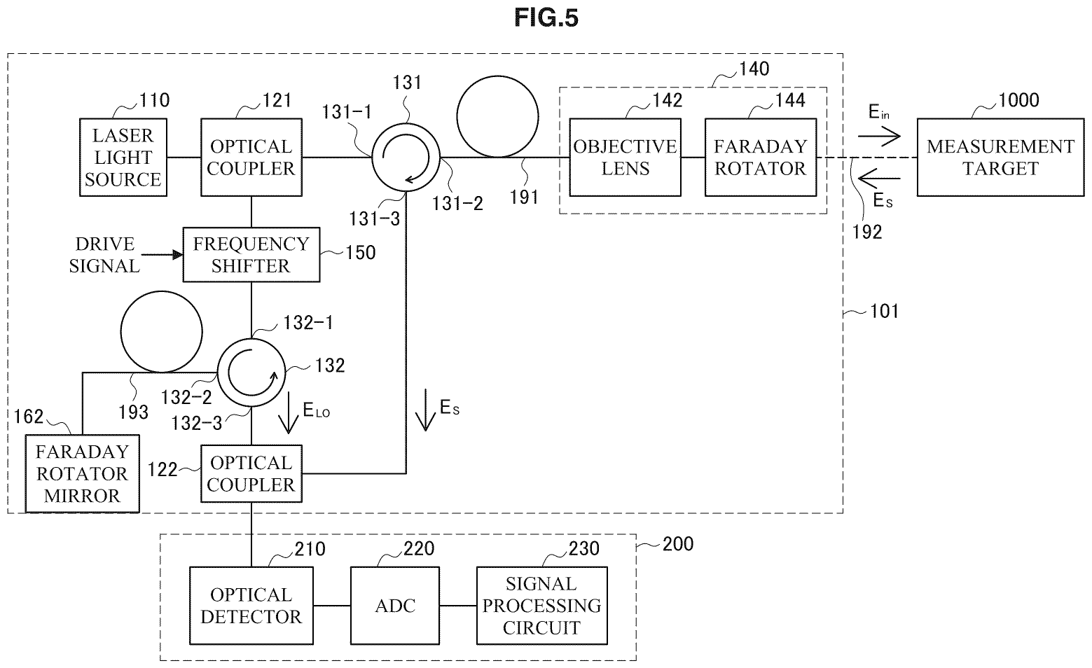

A laser Doppler vibrometer (hereinafter, also referred to as a second vibrometer) according to the second embodiment of the present invention will be described with reference to FIG. 5. FIG. 5 is a schematic view for describing the second vibrometer.

The second vibrometer measures vibration of a measurement target by detecting phase shift deriving from a Doppler effect included in measurement light, from the measurement light and local light using an optical interferometer similar to the first vibrometer. Here, an example will be described where heterodyne detection for causing the measurement light and the frequency-shifted local light to interfere with each other. However, a configuration where homodyne detection is performed may be employed.

The second vibrometer includes the laser light source 110, the first optical coupler 121, a first optical circulator 131 that is a first optical multiplexer/demultiplexer, the sensor head 140, the frequency shifter 150, a second optical circulator 132 that is a second optical multiplexer/demultiplexer, a faraday rotator mirror 162, and the second optical coupler 122 as an optical processing system. Furthermore, the second vibrometer includes the optical detector 210, the Analog-to-Digital Converter (ADC) 220, and the signal processing circuit 230 as the electrical processing system.

Since the configurations and the operations of the laser light source 110, the first optical coupler 121, the sensor head 140, and the frequency shifter 150 are the same as those of the first optical coupler, redundant description will be omitted.

Since the first optical circulator 131 employs the same configuration as that of the optical circulator of the first vibrometer, description overlapping that of the optical circulator of the first vibrometer may be omitted. The irradiation light sent from the first optical coupler 121 to the first optical circulator 131 is input to the first input/output port 131-1 of the first optical circulator 131. The irradiation light input to the first input/output port 131-1 is output from the second input/output port 131-1. The irradiation light output from the second input/output port 132-2 is sent to the sensor head 140 through the first optical path 191.

The sensor head 140 is the same as that in the first vibrometer. The sensor head 140 radiates the irradiation light Eᵢₙ having propagated through the first optical path 191 toward the measurement target 1000. Furthermore, the sensor head 140 receives the measurement light Eₛ reflected by the measurement target 1000 to propagate to the first optical path 191.

The light having propagated through the first optical path 191 is sent to the first optical circulator 131. The measurement light sent to the first optical circulator 131 through the first optical path 191 is input to the second input/output port 131-2 of the first optical circulator 131. The measurement light input to the second input/output port 131-2 is output from the third input/output port 131-3. The measurement light output from the third input/output port 131-3 is sent to the second optical coupler 122.

The local light E_{LO} sent from the first optical coupler 121 to the frequency shifter 150 is subjected to frequency shift by the frequency shifter 150. The frequency shifter 150 is the same as that in the first vibrometer.

Since the second optical circulator 132 employs the same configuration as that of the first optical circulator 131, description overlapping that of the first optical circulator 131 may be omitted. The local light sent from the frequency shifter 150 to the second optical circulator 132 is input to the first input/output port 131-2 of the second optical circulator 132. The local light input to the first input/output port 132-1 is output from the second input/output port 132-2. The local light output from the second input/output port 132-2 is sent to the faraday rotator mirror 162 through a third optical path 193.

The third optical path 193 includes long optical fibers similar to the first optical path 191. The length of the third optical path 193 is adjusted such that a propagation delay time produced at a time of propagation in the third optical path 193 is substantially the same as a propagation delay time produced at a time of propagation in the first optical path 191 and the second optical path 192. That is, although the optical path length of the third optical path 193 is preferably equal to the sum of the optical path lengths of the first optical path 191 and the second optical path 192, a difference between both of the delay times may be a coherence time of the laser light source 110 or less at most.

The faraday rotator mirror 162 non-reciprocally rotates the polarization of light input from an input/output end 90 degrees with respect to a polarization state using a faraday effect, and causes the light to be output from the input/output end.

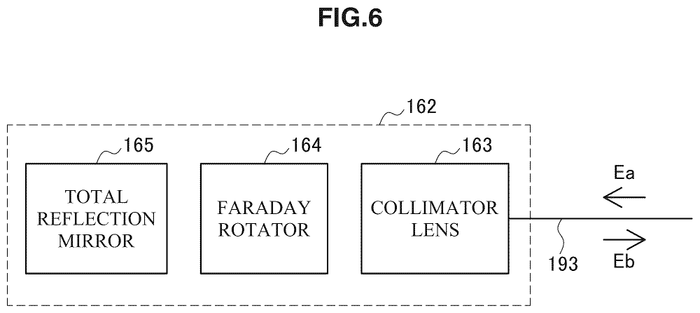

A configuration example of the faraday rotator mirror will be described with reference to FIG. 6. FIG. 6 is a schematic view for describing the faraday rotator mirror.

The faraday rotator mirror 162 includes a collimator lens 163, a faraday rotator 164, and a total reflection mirror 165. The faraday rotator 164 employs the same configuration as that of the faraday rotator 144 included in the sensor head 140, and non-reciprocally rotates the input light 45°.

Input light Ea propagating through the third optical path 193 and input to the faraday rotator mirror 162 is converted into a parallel beam by the collimator lens 163. The light converted into the parallel beam by the collimator lens 163 passes the faraday rotator 164, and then is reflected by the total reflection mirror 165. Subsequently, the light propagates in the opposite direction in the faraday rotator 164, is condensed by the collimator lens 163, and is output as output light Eb. The output light Eb is input to the third optical path 193, and propagates in the opposite direction in the third optical path 193 toward the second optical circulator 132.

At this time, according to an effect of the faraday rotator 164, a polarization of the output light Eb output from the faraday rotator mirror 162 rotates 90 degrees with respect to a polarization of the input light Ea. As a result, when the local light output from the second input/output port 132-2 propagates in the opposite direction in the third optical path 193 again through the third optical path 193 and the faraday rotator mirror 162, and initially emitted local light output from the laser light source is the x polarization, the polarization of the local light after backward propagation is the y polarization. Such a faraday rotator mirror is commercially available, and a suitable faraday rotator mirror among the faraday rotator mirrors can be used.

The output light Eb of the faraday rotator mirror 162 propagates in the opposite direction in the third optical path 193, is input to the second input/output port 132-2 of the second optical circulator 132, and is output from the third input/output port 132-3. The local light output from the third input/output port 132-3 is sent to the second optical coupler 122.

Note that, although an example has been described where the frequency shifter 150 is provided between the first optical coupler 121 and the second optical circulator 132, the frequency shifter 150 may be disposed in an optical path that connects a third input/output port 162-3 of the second optical circulator 132 and the second optical coupler 122.

The second optical coupler 122 causes the measurement light sent from the first optical circulator 131 and the local light sent from the second optical circulator 132 to interfere with each other. Interference light obtained when the measurement light and the local light interfere with each other in the second optical coupler 122 is sent to the optical detector 210.

Note that, although a case has been described where the first and second optical circulators are used as the first and second optical multiplexer/demultiplexers, respectively, the present invention is not limited to this. Similar to the case of the first vibrometer, a PBS may be used as the optical multiplexer/demultiplexer instead of an optical circulator.

Since the configurations and the operations of the optical detector 210, the ADC 220, and the signal processing circuit 230 that the second vibrometer includes as the electrical signal system are the same as those of the first vibrometer, redundant description will be omitted.

Generally, a light source has a finite spectral width (line width), and a coherence time is inversely proportional to the line width. When an output of the same light source is split by an optical coupler or the like, a delay time that exceeds the coherence time is given to one of the split outputs, and then the outputs are multiplexed again and caused to interfere with each other, even if polarizations of two light waves to be caused to interfere with each other are the same, both of the polarizations do not interfere with each other well, and it is difficult to detect a phase difference between the two light waves.

In view of the above, to cause the local light E_{LO} and the measurement light Eₛ to interfere with each other and measure vibration in the laser Doppler vibrometer, it is necessary to make a delay time difference between the local light E_{LO} and the measurement light Eₛ input to the second optical coupler 122 the coherence time of the laser light source 110 or less. Increase in the lengths of the optical fibers that are the first optical path 191 is concerned to make the above delay time difference longer than the coherence time of the laser light source 110.

To solve this problem, a delay time compensation optical path that has the length for compensating for the above delay time difference may be disposed in an optical path in which the local light E_{LO} is output from the first optical coupler 121 and is input to the second optical coupler 122. This delay time compensation optical path is desirably an optical fiber transmission path that has substantially the same length as the sum of the optical path lengths of the first optical path 191 and the second optical path 192.

On the other hand, when the local light propagates in this delay time compensation optical path, polarization rotation of the local light occurs in the delay time compensation optical path similar to the first optical path 191. Therefore, it is concerned that polarizations of the measurement light and the local light input to the second optical coupler 122 that is an optical interferometer do not match with each other (a case where the polarizations are orthogonal is also assumed in the worst case), and it is impossible to measure vibration of a measurement target.

The second vibrometer solves the above problem. That is, the delay time compensation optical path includes the second optical circulator 132, the third optical path 193 that includes optical fibers having substantially the same length as the sum of the optical path lengths of the first optical path 191 and the second optical path 192, and the faraday rotator mirror 162.

According to an effect of the second faraday rotator 164 included in the faraday rotator mirror 162, the local light input as the x polarization to the first input/output port 132-1 of the second optical circulator 132 is output as the y polarization from the third input/output port 132-3 at all times similar to that described for the operation of the first vibrometer. In this regard, the second optical circulator 132 is configured as a polarization maintaining optical system such as polarization maintaining fibers.

On the other hand, the polarization state of the measurement light output from the third input/output port 131-3 of the first optical circulator 131 is also the y polarization at all times.

Consequently, even though the second vibrometer does not include the polarization rotator 160, and the second optical coupler 122 multiplexes the measurement light and the local light as the y polarizations at all time, so that it is possible to obtain the same effect as that of the first vibrometer. Thus, the second vibrometer does not need the polarization rotator 160.

The second vibrometer according to the present invention can obtain the following effect in addition to the effect obtained by the first vibrometer. That is, even in a case where the first optical path 191 is configured as long optical fibers having the delay time that exceeds the coherence time of the laser light source 110, the second vibrometer includes the third optical path 193 including the optical fibers having substantially the same lengths as those of the first optical path 191, so that it is possible to cause the measurement light and the local light to interfere with each other with a delay time difference in the coherence time of the laser light source 110, and measure vibration.

Here, heterodyne detection has been described as the example for the operations of the first vibrometer and the second vibrometer. However, the effect of the present invention is not limited to heterodyne detection, and is also applicable to homodyne detection.

Since the electrical signal processing systems of the first vibrometer and the second vibrometer are the same as vibration measurement of a conventional homodyne or heterodyne method, an arbitrary, suitable, and conventionally known technology may be used. Signal processing performed by the system/circuit configuration as disclosed in, for example, JP 2022-67148 A may be performed.

Furthermore, the configuration of the sensor head 140 is not limited to a configuration where the objective lens 142 and the faraday rotator 144 illustrated in FIG. 1 are integrated as a module.

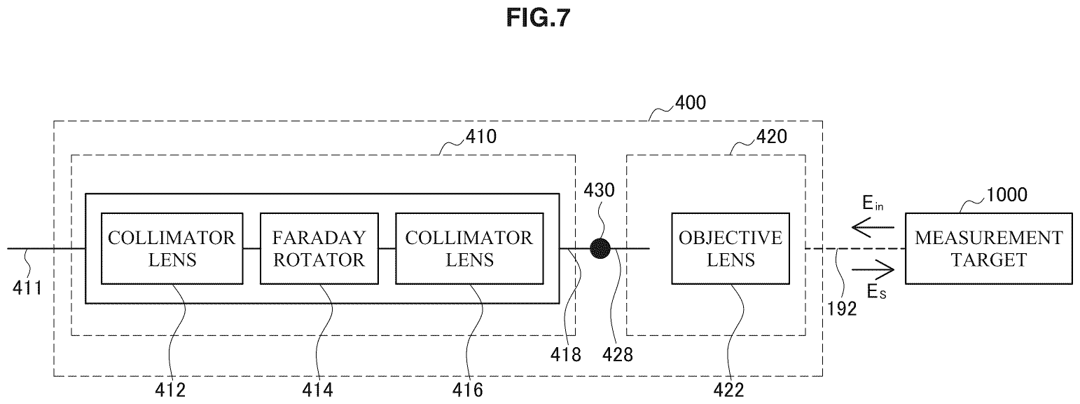

FIG. 7 is a schematic view illustrating an other configuration example of a sensor head. FIG. 7 illustrates an example where a faraday rotator module 410 and a fiber collimator module 420 separated as a faraday rotator and an objective lens of separate optical modules are used to configure a sensor head 400.

The faraday rotator module 410 is an optical module that inputs and outputs light to and from a faraday rotator 414 through pigtail optical fibers 411 and 418. Since it is necessary to convert light into a parallel beam when the light is input to or output from the faraday rotator 414, the faraday rotator module 410 includes collimator lenses 412 and 416 inside.

The fiber collimator module 420 converts fiber propagation light from a pigtail optical fiber 428 into a parallel beam or the like to input or output light to and from an external free space. The fiber collimator module 420 includes an objective lens 422 that is the same as that used in the first vibrometer to input and output light to and from the external free space.

The faraday rotator module 410 and the fiber collimator module 420 are optically coupled by pigtail optical fibers 418 and 428 to configure the sensor head 400.

These faraday rotator module 410 and fiber collimator module 420 are commercially available, and the appropriate faraday rotator module 410 and fiber collimator module 420 can be used according to the wavelength or the like.

The sensor head 400 employing the configuration as illustrated in FIG. 7 includes the pigtail optical fibers 418 and 428 in an optical path between the faraday rotator 414 and the measurement target 1000. An influence of birefringence or PDL on polarization rotation occurring in these two pigtail optical fibers remain even if the faraday rotator 414 is used as argued on the influence of birefringence or PDL in description of the operation of the first vibrometer.

It is desirable that the pigtail optical fibers 418 and 428 are configured as polarization maintaining optical fibers and have equal lengths, and are connected by rotating the optical axes 900 at a connection portion 430 to prevent occurrence of such polarization rotation.

Although details of the preferable embodiments of the present invention have been described above with reference to the appended drawings, the present invention is not limited thereto. It will be clear to a person of ordinary skill in the art of the present invention that various modifications and improvements may be obtained within the scope of the technical idea recited by the scope of the appended claims, and it should be understood that they will naturally come under the technical scope of the present invention.

What is claimed is:

1. A laser Doppler vibrometer comprising:
a first optical coupler configured to split laser light from a laser light source into two beams of laser light, and one of which is as irradiation light and an other is local light;
a sensor head configured to receive the irradiation light come from the first optical coupler through a first optical path, irradiate a measurement target with the irradiation light through a second optical path, receive, through the second optical path, measurement light obtained when the irradiation light is reflected by the measurement target, and cause the measurement light to propagate through the first optical path;
a second optical coupler configured to generate interference light by causing the measurement light having propagated through the first optical path and the local light to interfere with each other; and
an electrical processing system configured to calculate a vibration state of the measurement target from the interference light,
wherein the sensor head includes a faraday rotator that rotates a polarization 45°.

2. The laser Doppler vibrometer according to claim 1, further comprising:
an optical multiplexer/demultiplexer configured to output from a second input/output port the irradiation light having being input to a first input/output port and generated by the first optical coupler and cause the irradiation light to propagate through the first optical path, and output from a third input/output port the measurement light having being input to the second input/output port and having propagated through the first optical path; and
a polarization rotator configured to rotate 90° a polarization of the measurement light output from the third input/output port of the optical multiplexer/demultiplexer, and send the measurement light to the second optical coupler.

3. The laser Doppler vibrometer according to claim 1, further comprising:
a first optical multiplexer/demultiplexer configured to output from a second input/output port the irradiation light having being input to a first input/output port and generated by the first optical coupler and cause the irradiation light to propagate through the first optical path, and output from a third input/output port the measurement light having being input to the second input/output port and having propagated through the first optical path and send the measurement light to the second optical coupler;
a second optical multiplexer/demultiplexer configured to output from the second input/output port the local light having being input to the first input/output port and generated by the first optical coupler and cause the local light to propagate through a third optical path, and output from the third input/output port the local light having being input to the second input/output port and having propagated through the third optical path and send the local light to the second optical coupler; and
a faraday rotator mirror provided on an opposite side of the third optical path to the second optical multiplexer/demultiplexer.

4. The laser Doppler vibrometer according to claim 3, wherein an optical path length of the third optical path is equal to a sum of optical path lengths of the first optical path and the second optical path.

5. The laser Doppler vibrometer according to claim 2, wherein the optical multiplexer/demultiplexer is an optical circulator.

6. The laser Doppler vibrometer according to claim 2, wherein the optical multiplexer/demultiplexer is a polarization beam splitter.

7. A vibration measurement method comprising:
splitting laser light into two beams of laser light, and generating one beam of the laser light as irradiation light and an other beam of the laser light as local light;
receiving the irradiation light through a first optical path, rotating a polarization 45°, and then irradiating a measurement target with the irradiation light through a second optical path;
receiving, through the second optical path, measurement light obtained when the irradiation light is reflected by the measurement target, then rotating a polarization 45°, and causing the measurement light to propagate through the first optical path;
generating interference light by causing the measurement light having propagated through the first optical path and the local light to interfere with each other; and
acquiring information of vibration of the measurement target from the interference light,
wherein the polarization is rotated 45° twice non-reciprocally.

8. The vibration measurement method according to claim 7, further comprising rotating 90° the polarization of the measurement light having propagated through the first optical path before generating the interference light.

9. The vibration measurement method according to claim 7, further comprising:
causing the local light to propagate through a third optical path before generating the interference light;
rotating 90° a polarization of the local light having propagated through the third optical path; and
causing the local light whose polarization has been rotated 90° to propagate through the third optical path again.

10. The vibration measurement method according to claim 9, wherein
rotating the polarization of the local light 90° includes
rotating 45° the polarization of the local light having propagated through the third optical path, and then totally reflecting the polarization, and
rotating 45° the polarization of the totally reflected local light, and then causing the local light to propagate through the third optical path again, and
the polarization of the local light is rotated 45° twice non-reciprocally.

11. The vibration measurement method according to claim 9, wherein an optical path length of the third optical path is equal to a sum of optical path lengths of the first optical path and the second optical path.
